(19) United States
(12) Patent Application Publication
(10) Pub. No.: US 2016/0340203 A1
(43) Pub. Date: Nov. 24, 2016

(54) CLEANER SYSTEM, SEPARATOR, AND RELATED METHODS

(71) Applicant: WWAI Innovations, LLC, Fernandina Beach, FL (US)

(72) Inventor: Stuart G. DAVIS, Fernandina Beach, FL (US)

(21) Appl. No.: 14/715,756

(22) Filed: May 19, 2015

(51) Int. Cl. C02F 1/00; B01D 33/44; B01D 33/03

(52) U.S. Cl. CPC C02F 1/004; B01D 33/03; B01D 33/44

(57) ABSTRACT

In a facility producing a liquid stream containing solids and/or semisolids that is passed through a separator including a vibratory screen with screen openings sized to allow the flow of the liquid stream through the screen while capturing the solids and/or semisolids from the liquid stream, a cleaning system is provided that includes at least one cleaner element constructed and arranged in the separator to allow impact of the cleaner element against the vibratory screen to dislodge at least a portion of the solids and/or semisolids occluded in the screen openings during use of the separator. The cleaner element is larger in size than the screen openings and is made at least in part of non-synthetic animal hide (e.g., leather), synthetic animal hide, or a combination thereof. A method and a separator are also provided.

### FIELD OF THE INVENTION

This invention relates to systems, apparatus, and methods of treating industrial liquid, such as aqueous and other liquid streams containing organic and/or inorganic compounds, from a variety of sources including but not limited to industrial laundries, food processing, manufacturing plants, printing processes, and those industries where organic and/or inorganic matter is present in a wastewater or other liquid matrix.

### BACKGROUND

Environmental regulations and growing concerns over the environment dictate the cleaning of industrial liquid streams, such as wastewater streams, for industrial processes such as industrial laundries, food processes, and automotive and other manufacturing and production systems. By way of example, industrial laundries produce effluents that include dirt, grease, and oils removed from soiled articles such as towels, linen, and clothing. Processing of wastewater effluents and similar liquid streams used to clean such articles may involve such steps as sedimentation, straining, flotation, filtration, coagulation, flocculation, among others, not necessarily in that order.

Suspended solid separators such as shaker screens are known for the removal of debris. Shaker screens may have one, two, three, or more decks for separating and classifying different size solids from one another or simply separating the solids from a main flow. When used for separating solids from aqueous and other liquid streams, shaker screens, despite their vibratory and/or rotational motion, can become partially clogged or “blinded” with semi-solids such as oil and grease that occlude in the screen openings and/or solid debris small enough to become stuck in but too large to pass through the screen openings. The oil, grease, debris, and other particles can agglomerate on the screen openings and quickly reduce the number of unblocked screen openings. As a result, the available surface area of unblocked screen openings decreases and lowers throughput. If left unattended, complete “blinding” (clogging) of the screen can result. Accordingly, it may become necessary to disrupt and temporarily suspend the liquid stream flow through the shaker screens while the solid separators are immobilized for screen cleaning and/or replacement. Such maintenance can result in production downtimes at relatively frequent intervals, which in turn reduce the efficiency of the process and increase production expenses.

### SUMMARY OF THE INVENTION

According to a first aspect of the invention, a cleaning system is provided in a facility producing a liquid stream containing solids and/or semisolids (“(semi)solids”) that is passed through a separator including a vibratory screen with screen openings sized to allow the flow of the liquid stream through the screen while capturing the (semi)solids from the liquid stream. The cleaning system in the facility includes at least one cleaner element constructed and arranged in the separator to allow impact of the cleaner element against the vibratory screen to dislodge at least a portion of the (semi)solids occluded in the screen openings during use of the separator in the facility. The cleaner element is larger in size than the screen openings and is made at least in part of non-synthetic animal hide, synthetic animal hide, or a combination thereof.

In a second aspect of the invention, a process is provided for separating (semi)solids from a liquid stream. According to the process, the liquid stream is passed through a separator including a vibratory screen and a cleaning system. The vibratory screen has screen openings sized to allow the flow of the liquid stream through the screen while capturing the (semi)solids from the liquid stream. The cleaning system includes at least one cleaner element constructed and arranged in the separator to allow impact of the cleaner element against the vibratory screen to dislodge at least a portion of the (semi)solids occluded in the screen openings during use of the separator. The cleaner element is larger in size than the screen openings and is made at least in part of non-synthetic animal hide, synthetic animal hide, or a combination thereof.

According to a third aspect of the invention, a separator is provided that includes at least a vibratory screen and a cleaner element. The vibratory screen has screen openings sized to allow the flow of a liquid stream through the screen openings of the vibratory screen while capturing (semi)solids contained in the liquid stream. The cleaner element is constructed and arranged in the separator to allow impact of the cleaner element against the vibratory screen to dislodge at least a portion of the (semi)solids occluded in the screen openings during use of the separator. The cleaner element is larger in size than the screen openings and is made at least in part of non-synthetic animal hide, synthetic animal hide, or a combination thereof.

In an exemplary embodiment of any and/or each of the above aspects, the cleaner element includes at least an inflatable bladder in a partially inflated state and a surrounding cover that is made at least in part of the non-synthetic animal hide, the synthetic animal hide, or the combination thereof.

In another exemplary embodiment of any and/or each of the above aspects, the non-synthetic animal hide, the synthetic animal hide, or the combination thereof forms the outer surface of the cleaner element.

In still another exemplary embodiment of any and/or each of the above aspects, the non-synthetic animal hide, the synthetic animal hide, or the combination thereof includes at least a plurality of panels stitched together.

In a further exemplary embodiment of any and/or each of the above aspects, the cleaner element is in the form of a spheroid, ellipsoid, or polyhedron.

In still a further exemplary embodiment of any and/or each of the above aspects, the facility is an industrial laundry and the liquid stream includes at least an aqueous effluent from a washing apparatus.

In yet another exemplary embodiment of any and/or each of the above aspects, the cleaner element comprises a cover with a surface roughened by abrasion of the cover against the vibratory screen, the roughened surface including protuberances extending generally outward and having a diameter smaller than the screen openings.

Other aspects of the invention, including apparatus, devices, systems, separators, processes, and the like which constitute part of the invention will become more apparent upon reading the following detailed description of the exemplary embodiments.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a side view of a separator for a facility producing a liquid stream containing (semi)solids that is passed through the separator;

FIG. 2 is a cross-sectional view taken along sectional line II-II of FIG. 1, showing a vibratory screen;

FIG. 3 is a front view of a cleaner element according to an exemplary embodiment of the invention;

FIG. 4 illustrates the cleaner element of FIG. 3 partially cut away to reveal a bladder positioned within a cover of the cleaner element; and

FIG. 5 is an enlarged view of the fragment of a roughened surface of the cleaner element shown circle V of FIG. 3.

### DETAILED DESCRIPTION OF THE EXEMPLARY EMBODIMENTS AND EXEMPLARY PROCESSES

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

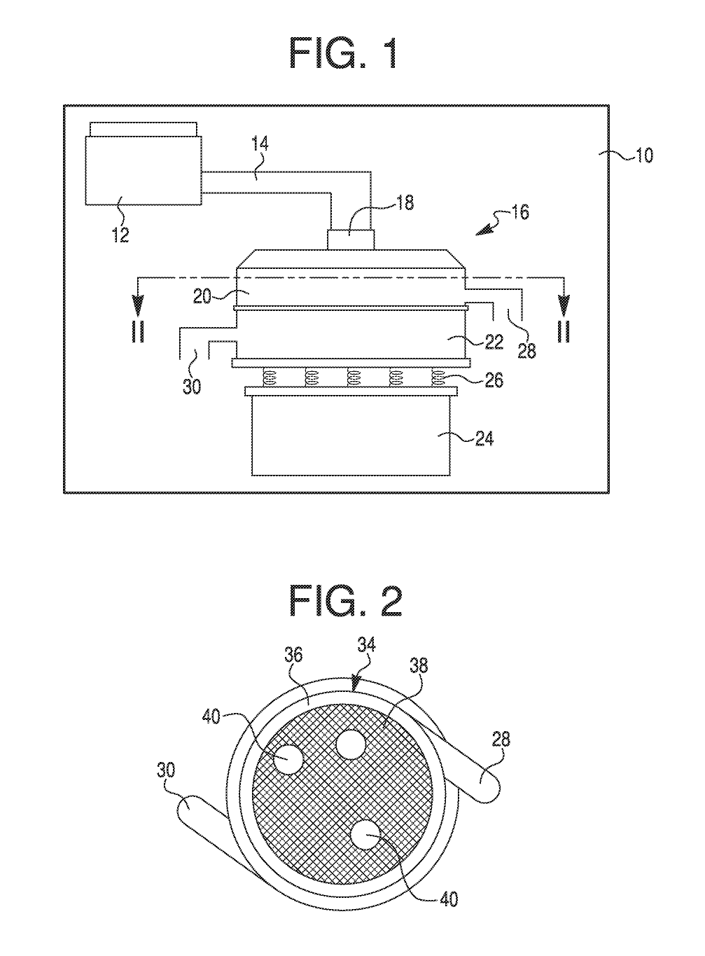

FIG. 1 illustrates a facility 10 including an industrial laundry machine 12 for producing a liquid stream containing solids and/or semisolids (herein individually and collectively referred to as “(semi)solids”). The (semi)solids may be or include, for example, waste particles, dirt, oil, and grease. Although the facility 10 is illustrated in connection with an industrial laundry operation, it should be understood that the principles of the present invention can be applied to other facilities and other machines, including those associated with food production, printing, and various manufacturing and production systems. A liquid stream containing the (semi)solids is passed through conduit 14 from the industrial washing machine 12 to the inflow port 18 of a liquid-solid separator 16. Although not shown in FIG. 1, other equipment, including for example a holding tank, may be positioned upstream of the washing machine, interposed between the industrial washing machine 12 and the solid separator 16, or positioned downstream of the separator 16 to further process, accumulate, or otherwise treat or hold the liquid stream. Both the industrial washing machine 12 and the separator 16 are shown associated with the same facility 10. It should be understood that the industrial washing machine 12 and the separator 16 may be located in the same or different buildings of the facility 10.

The inflow port 18 empties the incoming liquid stream (or influent flow) into an upper housing 20 enclosing a first circular chamber. The upper housing 20 sits on and is connected to a lower housing 22. A base 24 with a vibratory mechanism is positioned below the upper and lower housings 20, 22, and includes spring-like elements 26 that support the housings 20, 22. The vibratory mechanism of the base 24 may cause the upper and lower housings 20, 22 to undergo high frequency oscillation or reversals in direction) in directions that may include side to side, up and down, and/or rotationally back and forth. Solid separators 16 are well known and may include, but are not limited to, those commercially available from Sweco, Giant Finish, Inc., Kemco and Systems, Thermal Engineering of Arizona, Inc., among others.

FIG. 2 illustrates an exemplary vibratory screen (also known in the art as a shaker screen) 34 having a peripheral solid flange 36 surrounding and tautly supporting a screen mesh 38 having screen openings. The vibratory screen 34 is secured to the bottom of the upper housing 20 or between the upper housing 20 and lower housing 22 to separate the respective chambers of the housings 20, 22. The chamber of the upper housing 20 is associated with an upper outlet (also referred to as a solids discharge throat) 28 positioned substantially tangentially along the periphery of the upper housing 20. Likewise, the chamber of the lower housing 22 is associated with a lower outlet (also referred to as a liquid discharge throat) 30 positioned substantially tangentially along the periphery of the lower housing 22. The upper outlet 28 and the lower outlet 30 are substantially diametrically opposed to one another in the illustrated embodiment, but may be otherwise arranged. Although not shown, the separator 16 may include additional housings, housing chambers, and shaker screens. Multiple shaker screens with different size screen openings can be employed to classify the removed solid particles.

As further shown in FIG. 2, one or more cleaner elements 40 are arranged in the chamber of the upper housing 20. Although not shown, the cleaner elements 40 may additionally or alternatively be arranged in the chamber of the lower housing 22. The cleaner elements 40 are sized larger than the screen openings of the screen mesh 38 so as to prevent passage of the cleaner elements 40 through the screen 34. Depending upon whether the cleaner elements 40 are located in the chamber of the upper housing 20 or the chamber of the lower housing 22, the cleaner elements 40 are also sized larger than the discharge throats 28, 30 to prevent accidental expulsion of the cleaner elements from the separator 16. The desired size of the cleaner elements 40 may vary depending upon the separator 16 selected. Generally, cleaner elements 40 with a dimension (typically diameter or length) of about 4 inches to about 14 inches (for example, about 6 inches) will suffice to clean the vibratory screen 34.

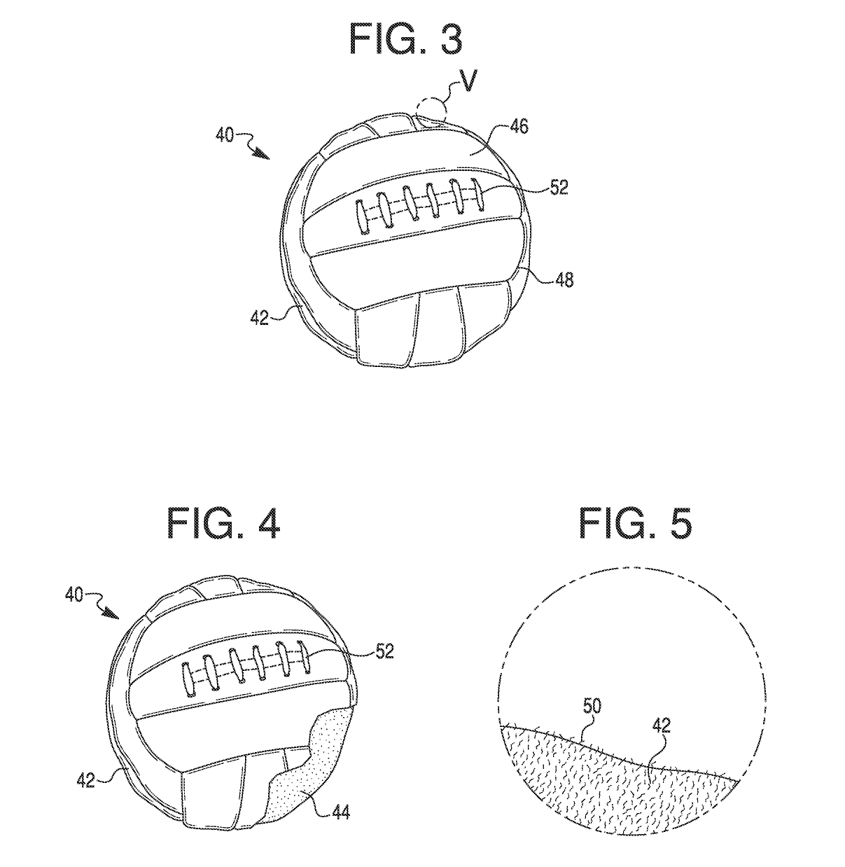

Referring now more particularly to FIGS. 3 and 4, in accordance with certain exemplary embodiments the cleaner elements 40 are in the form of a spheroid, ellipsoid, or polyhedron, or a combination thereof, although other shapes may be used. The cleaner elements 40 are made at least in part of non-synthetic animal hide, synthetic animal hide, or a combination of non-synthetic animal hide and synthetic animal hide. The preferred non-synthetic animal hide useful in connection with the exemplary embodiments disclosed herein is treated (e.g., tanned) or untreated natural leather. In certain exemplary embodiments, one or more of the cleaner elements 40 include a cover 42 with an outer surface made at least in part of the non-synthetic animal hide, the synthetic animal hide, or the combination thereof. Optionally, a coating may be applied to the surrounding cover 42, for example, to increase the abrasiveness or increase the wear protection of the cleaner elements 40. Although multiple cleaner elements 40 are shown in FIG. 2, it should be understood that the systems and methods of exemplary embodiments disclosed herein may be operated with a single cleaner element.

As best shown in FIG. 4, the cleaner elements 40 further include an inflatable bladder 44 surrounded by the cover 42. The bladder 44 may be made of a flexible rubber material. Using cleaner elements 40 having the inflatable bladder 44 in a partially (that is not fully) inflated state may be desired in accordance with exemplary embodiments, because the partially inflated state of the cleaner elements 40 may reduce the wear-and-tear by decreasing pounds per square inch of the cleaner elements 40 while allowing the cleaner elements 40 to reach further into corners and tight spaces, such as the portions of the screen mesh 38 attached to and in close proximity to the screen flange 36.

Another potential benefit of selecting animal hide, especially leather, for the surrounding cover 42 and using an underinflated inner bladder 44 is that repeated impact, such as in a scrubbing manner, of the cleaner elements 40 against the screens 34 abrades the animal hide. The resulting abraded surface of the animal hider thereby develops thin protuberances 50 (FIG. 5) extending generally outward. The threads 50 have diameters smaller than the screen openings of typical screen meshes 38. As the cleaner elements 40 impact the vibratory screen 34, the protuberances 50 may pierce through the (semi)solid materials, especially oils and greases, partially clogging or blinding the openings of the screen mesh 38.

The structure and materials of the cleaner elements 40 may resemble those of conventional soccer balls and volleyballs, with the covers 42 of the cleaner elements 40 comprising a plurality of panels 46 stitched together with stitching 48, such as nylon thread. However, the sizes of the cleaner elements 40 are typically smaller than those of conventional soccer balls and volleyballs. A set of laces or lacing 52 is shown on one of the panels, although it should be understood that the laces 52 may be present on two, three, four, or more panels distributed about the surface of the cover 42. The laces 52 improve the scrubbing action of the cleaner elements 40.

The cleaner elements 40 can be enhanced through cleaning procedures (e.g., sanitizing) or treated (e.g., embedded) with antimicrobial substances. The use of such antimicrobial substances is especially desirable in connection with the use of exemplary embodiments in food processing industries.

A process according to an exemplary embodiment of the invention will now be explained in connection with the drawings. The liquid influent containing the (semi)solids is directed from the industrial washing machine 12 of the facility 10 through the conduit 14 to the inflow port 18 of the solid-liquid separator 16 of the facility 10. The vibratory screen 34 separates suspended (semi)solids too large to pass through the openings of the screen mesh 38 from the liquid influent as the influent flows from the upper housing 20 chamber through the screen mesh 38 into the lower housing 22 chamber. The vibratory motion imparted by the vibrating mechanism of the base 24 causes the separated (semi)solids not clogging the vibratory screen 34 to move outward to the periphery of the screen 34 and discharge through the solids discharge throat 28. The remainder of the liquid stream with any suspended (semi)solids too small to be filtered by the vibratory screen 34 is discharged as a liquid effluent through the liquid discharge throat 30 for further processing or disposal. Such further processing may involve, for example, sedimentation, straining, flotation, further filtration, coagulation, flocculation, among other steps, not necessarily in that order. Although not shown, additional processing steps may be interposed between the industrial washing apparatus 10 and the suspended solid separator 14. While this exemplary embodiment has been described and illustrated in connection with an industrial washing apparatus, it should be understood that the process may be practiced in accordance with other applications and in other industries, such as food processing, manufacturing and processing plants, printing, and those industries where organic and/or inorganic matter is present in a wastewater matrix.

One, two, three, four, or more cleaner elements 40 are loaded in the separator 16 prior to feeding the influent flow into the separator 16. FIG. 2 illustrates the cleaner elements 40 positioned in the chamber of the upper housing 20, although it should be understood that the cleaner element(s) 40 also or alternatively may be positioned in the chamber of the lower housing 22. The vibratory motion imparted by the vibratory mechanism of the base 24 through the spring elements 26 to the housings 20, 22 causes the cleaner elements 40 to randomly move about the chamber(s) of the housing(s) 20 and/or 22 and repeatedly and randomly impact different areas of the vibratory screen 34, except perhaps the most outer edge near the screen flange 36. The motion of the cleaner elements 40 relative to the screen mesh 38 may resemble that of a scrubbing motion. The force of impact and general scrubbing interaction between the cleaning elements 40 and the vibratory screen 34 dislodge at least a portion and preferably all of the (semi)solids occluded in the screen openings during use of the separator 16. The construction of the cleaner elements 40 from animal hide and the arrangement of the cleaner elements in the housing(s) 20 and/or 22 to impact against (e.g., scrub) the vibratory screen 34 allows the cleaner elements 40 to reduce or eliminate the clogging and blinding effects of the (semi)solids on the vibratory screen 34. The cleaner elements 40 clean the vibratory screen 34 by, for example, breaking apart agglomerated (semi)solids and/or scrubbing the surface of the vibratory screen 34. The broken, loosened, and dislodged (semi)solids may be discharged with other matter through the solids discharge throat 28 and/or the liquid discharge throat 30.

The inventor has found that the animal hide material, especially in a partially inflated state, allows the cleaner elements 40 to possess sufficient mass and surface area to clean with little or reduced damage to the vibratory screen 34. The inventor also has found that the use of such cleaner elements 40 is superior in several respects to solid rubber balls. Although solid rubber balls as the cleaner elements impact the screen 34 and marginally break down and dislodge greases, debris, and other particles occluded in the screen 34, the relatively heavy weight, hardness, and elasticity of rubber balls cause them to bounce and rebound within the chambers with high energy. Problematically, the forceful and high speed impact of rubber balls against the screen 34 can cause wear and tear and eventually failure of the screen 34, as well as erosion to the rubber balls and damage to other components of the separator 16. To address these problems, it may become necessary to suspend the liquid influent stream into the industrial washing machine 16 (or other apparatus) to allow its disassembly for repair, upkeep, and maintenance, such as replacement of screens and/or substitution of new rubber cleaner balls. Such suspensions and machine stoppage, if conducted at relatively frequent intervals, can result in long downtimes that deleteriously lower throughput and increase expense. It is believed that the use of the cleaner elements 40 described herein significantly reduces the need for such maintenance.

The following examples are provided by way of description and are not necessarily limiting of the scope of the invention and the exemplary embodiments described herein.

### Example 1

A vibratory shaker screen to remove lint and other debris prior to wastewater pretreatment was placed in an 80,000 gallon per day industrial laundry that washed a variety of inputs from uniforms to shop towels. Federally mandated changes to the time of surfactant required a plant based material be used. This caused the shaker screen to become blinded with grease and particles bound to the grease on a daily basis and the requirement that manpower be used to clean it along with chemicals and water.

An 11 inch spheroid was placed into the intake vessel side of the shaker screen. The spheroid was partially inflated and had a leather surface coated with a rubberized abrasive coating that quickly wore off in use. The spheroid with the exposed leather cover continued to operate in place. The amount of time spent cleaning the screen was reduced to once every two weeks. Cleaning was performed to check the operation of the screen and rinse the ball.

A comparative test was conducted on a shaker screen for a period of two weeks at an industrial laundry. A 6″×6″ section was marked off and cleaned to remove all apparent surface debris. The screen was then put into operation without cleaner elements and operated for a period of one work week. The debris in the aforementioned area was removed and weighed. 40.6 grams of debris was captured on the screen. The device was placed into use and the screen restarted and ran for a second one-week period. The same procedure was followed with a result of 19.5 grams of debris captured on the screen. This is an increased efficiency of 52%

### Example 2

A vibratory shaker screen to remove lint and other debris prior to wastewater pretreatment was placed in a 100,000 gallon per day industrial laundry that washed a variety of inputs from uniforms to shop towels. Federally mandated changes to the time of surfactant required a plant based material be used. This caused the shaker screen to become blinded with grease and particles bound to the grease on a twice daily basis and the requirement that manpower be used to clean it along with chemicals and water.

An 11 inch spheroid that was partially inflated and had a leather cover was placed into the intake vessel side of the shaker screen. The spheroid operated in place. The amount of time spent cleaning the screen was reduced to once a week. Cleaning on a weekly basis was performed to check the operation of the screen and rinse the ball.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes specific examples to accomplish a more general goal that may be accomplished in another way.

Only those claims which use the words “means for” are to be interpreted under 35 USC 112, sixth paragraph. Moreover, no limitations from the specification are to be read into any claims, unless those limitations are expressly included in the claims.

What is claimed is:

1. In a facility producing a liquid stream containing (semi)solids that is passed through a separator comprising a vibratory screen with screen openings sized to allow the flow of the liquid stream through the screen while capturing the (semi)solids from the liquid stream in the facility, a cleaning system comprising at least one cleaner element constructed and arranged in the separator of the facility to allow impact of the cleaner element against the vibratory screen to dislodge at least a portion of the (semi)solids occluded in the screen openings during use of the separator, wherein the cleaner element is larger in size than the screen openings and is made at least in part of non-synthetic animal hide, synthetic animal hide, or a combination thereof.

2. In the facility of claim 1, wherein the cleaner element comprises an inflatable bladder in a partially inflated state and a surrounding cover that is made at least in part of the non-synthetic animal hide, the synthetic animal hide, or the combination thereof.

3. In the facility of claim 2, wherein the surrounding cover is in the form of a spheroid, ellipsoid, or polyhedron.

4. In the facility of claim 2, wherein the surrounding cover is made of non-synthetic animal hide.

5. In the facility of claim 4, wherein the non-synthetic animal is processed leather.

6. In the facility of claim 3, wherein the surrounding cover comprises a plurality of panels stitched together to form the spheroid, ellipsoid, or polyhedron.

7. In the facility of claim 2, wherein the surrounding cover defines an outer surface of the cleaner element.

8. In the facility of claim 2, wherein the surrounding cover comprises an abraded surface with protuberances extending generally outward and having a diameter smaller than the screen openings.

9. In the facility of claim 1, wherein the facility is an industrial laundry and wherein the liquid stream comprises an aqueous effluent from a washing apparatus.

10. A process for separating (semi)solids from a liquid stream, comprising:
passing the liquid stream through a separator comprising a vibratory screen and a cleaning system, the vibratory screen having screen openings sized to allow the flow of the liquid stream through the screen while capturing the (semi)solids from the liquid stream, the cleaning system comprising at least one cleaner element constructed and arranged in the separator to allow impact of the cleaner element against the vibratory screen to dislodge at least a portion of the (semi)solids occluded in the screen openings during use of the separator, wherein the cleaner element is larger in size than the screen openings and is made at least in part of non-synthetic animal hide, synthetic animal hide, or a combination thereof.

11. The process of claim 10, wherein the cleaner element comprises an inflatable bladder in a partially inflated state and a surrounding cover that is made at least in part of the non-synthetic animal hide, the synthetic animal hide, or the combination thereof.

12. The process of claim 11, wherein the surrounding cover is in the form of a spheroid, ellipsoid, or polyhedron.

13. The process of claim 11, wherein the surrounding cover is made of non-synthetic animal hide.

14. The process of claim 13, wherein the non-synthetic animal is processed leather.

15. The process of claim 12, wherein the surrounding cover comprises a plurality of panels stitched together to form the spheroid, ellipsoid, or polyhedron.

16. The process of claim 11, wherein the surrounding cover defines an outer surface of the cleaner element.

17. The process of claim 11, wherein the surrounding cover comprises an abraded surface with protuberances extending generally outward and having a diameter smaller than the screen openings.

18. The process of claim 10, wherein the liquid stream comprises an aqueous effluent from an industrial laundry washing apparatus.

19. In process of claim 10, wherein the impact of the cleaner element against the vibrator screen is a scrubbing action.

20. A separator comprising:
a vibratory screen with screen openings sized to allow the flow of a liquid stream through the vibratory screen while capturing (semi)solids contained in the liquid stream; and
a cleaner element constructed and arranged in the separator to allow impact of the cleaner element against the vibratory screen to dislodge at least a portion of the (semi)solids occluded in the screen openings during use of the separator,
wherein the cleaner element is larger in size than the screen openings and is made at least in part of non-synthetic animal hide, synthetic animal hide, or a combination thereof.
